(19) United States
(12) Patent Application Publication
(10) Pub. No.: US 2008/0267793 A1
(43) Pub. Date: Oct. 30, 2008

(54) COOLING FAN

(75) Inventors: ZHI-YA YANG, Shenzhen (CN); YING-MIN HUANG, Tu-Cheng (TW); YEU-LIH LIN, Tu-Cheng (TW)

Correspondence Address: PCE INDUSTRY, INC.;ATT. CHENG-JU CHIANG, 458 E. LAMBERT ROAD, FULLERTON, CA, 92835, US

(73) Assignee: FOXCONN TECHNOLOGY CO., LTD., Tu-Cheng (TW)

(21) Appl. No.: 11/762,988

(22) Filed: Jun. 14, 2007

(30) Foreign Application Priority Data
Apr. 25, 2007 (CN) 200710074208.8

(51) Int. Cl. F04B 17/03; H02K 15/02

(52) U.S. Cl. 417/354; 310/254

(57) ABSTRACT

A cooling fan includes a fan housing (30) having a central tube (34) extending upwardly therefrom, a bearing (61) received in the central tube and defining a bearing hole (62) therein, a stator (20) mounted around the central tube, and a rotor (10) including a hub (12) having a shaft (18) extending from the hub into the bearing hole of the bearing. The stator includes a stator core, and upper and lower insulating frames (28a, 28b) respectively located at upper and lower sides of the stator core. An oil retaining structure (288) is integrally formed with the upper insulating frame, and extends inwardly from a top of the upper insulating frame to an outer surface of the shaft.

### BACKGROUND OF THE INVENTION

1. Field of the Invention

The present invention relates to a cooling fan, and more particularly relates to a cooling fan having good lubricating characteristics.

2. Description of Related Art

With the continuing development of the electronic technology, electronic packages such as CPUs (central processing units) are generating more and more heat that requires immediate dissipation. Cooling fans are commonly used in combination with heat sinks for cooling the CPUs. Cooling fan performance mostly depends on performance characteristics of a bearing used thereby. Good lubricating qualities of the bearing increases the life-span of the bearing.

Referring to FIG. 7, a conventional cooling fan comprises a rotor 1 having a shaft 2 extending downwardly from a central portion of the rotor 1, a bearing 3 defining an inner hole for receiving the shaft 2 therein, and a frame 4. A central tube 5 extends upwardly from a middle portion of the frame 4 and defines a through hole 7 therein. The bearing 3 impregnated with lubricant oil is secured in the through hole 7 of the central tube 5 to rotatably support the rotor 1. An oil retaining ring 6 is mounted around the shaft 2 and located above a top end of the bearing 3 when the cooling fan is assembled. A gap is defined between a circumferential surface of the oil retaining ring 6 and an inner circumference of a top end of the central tube 5. During operation of the cooling fan, the oil originating from the bearing 3 passes out through the gap and is lost. Lubrication of the bearing 3 is thus gradually diminished. The friction between the shaft 2 and the bearing 3 increases, resulting in noise or malfunctioning. Finally the performance of the cooling fan is reduced, and the life-span is shortened in result.

What is needed, therefore, is a cooling fan which can reduce or eliminate lubricant oil loss.

### SUMMARY OF THE INVENTION

According to a preferred embodiment of the present invention, a cooling fan includes a fan housing having a central tube extending upwardly therefrom, a bearing received in the central tube and defining a bearing hole therein, a stator mounted around the central tube, and a rotor including a hub having a shaft extending from the hub into the bearing hole of the bearing. The stator includes a stator core, and upper and lower insulating frames respectively located at upper and lower sides of the stator core. An oil retaining structure is integrally formed with the upper insulating frame, and extends inwardly from a top of the upper insulating frame to an outer surface of the shaft. A buffer is defined between the central tube, a top surface of the bearing and the flange whereby when the shaft rotates, lubrication oil in the bearing which creeps out of the bearing through the top surface thereof can be received in the buffer and from where the oil can be guided to return into bearing through a channel defined in an outer surface of the bearing and a bottom face of the bearing.

Other advantages and novel features of the present invention will be drawn from the following detailed description of the preferred embodiments of the present invention with attached drawings, in which:

### BRIEF DESCRIPTION OF THE DRAWINGS

Many aspects of the present cooling fan can be better understood with reference to the following drawings. The components in the drawings are not necessarily drawn to scale, the emphasis instead being placed upon clearly illustrating the principles of the present cooling fan. Moreover, in the drawings, like reference numerals designate corresponding parts throughout the several views.

FIG. 1 is an isometric, exploded view of a cooling fan in accordance with a preferred embodiment of the present invention;

FIG. 2 is an isometric, assembled view of the cooling fan of FIG. 1;

FIG. 3 is a cross-sectional view of the cooling fan taken from line III-III of FIG. 2;

FIG. 4 is an isometric view of an upper insulating frame of the cooling fan of FIG. 1.

FIG. 5 is a cross-sectional view of the upper insulating frame taken from line V-V of FIG. 4;

FIG. 6 is an enlarged view of a bearing of the cooling fan of FIG. 1; and

FIG. 7 is a cross-sectional view of a conventional cooling fan.

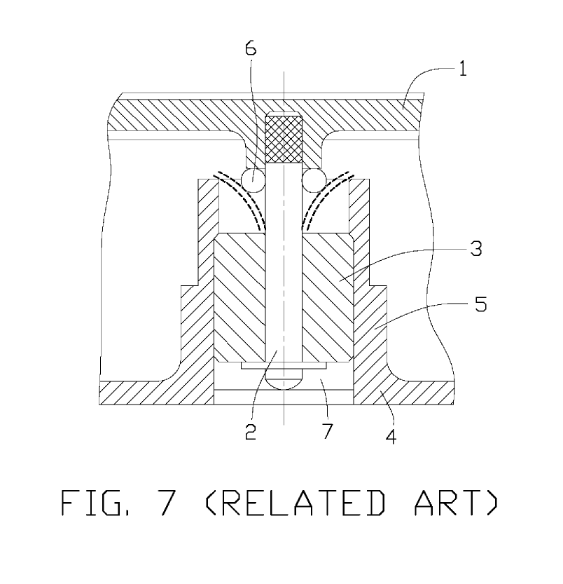

### DETAILED DESCRIPTION OF THE INVENTION

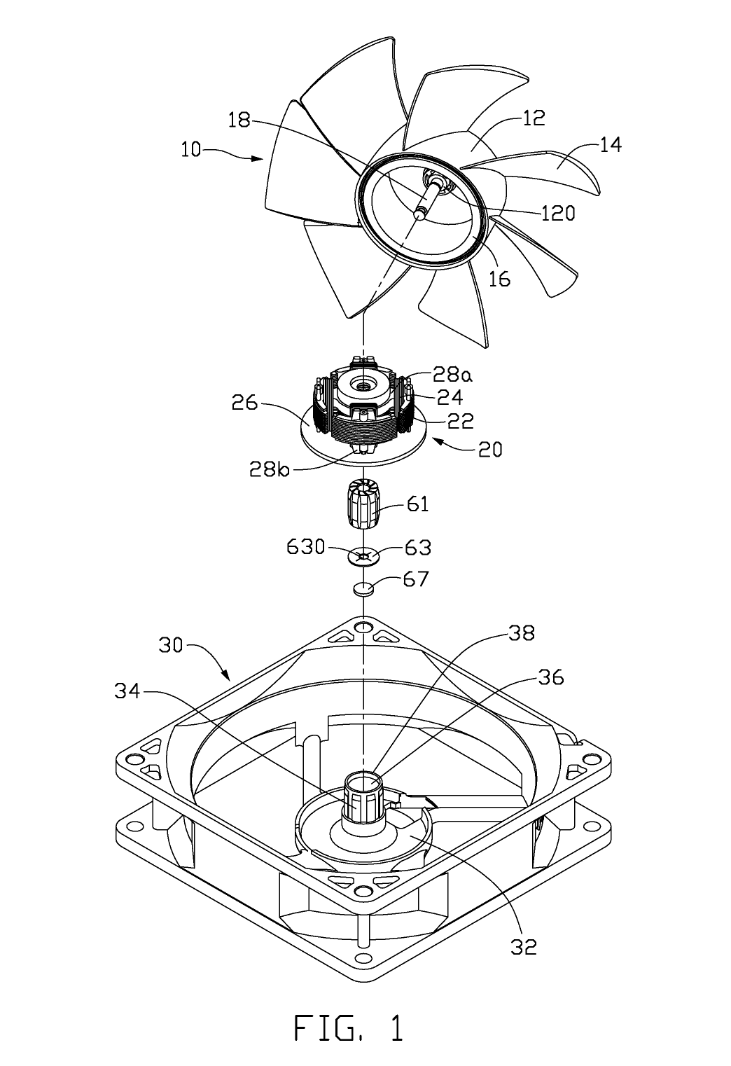

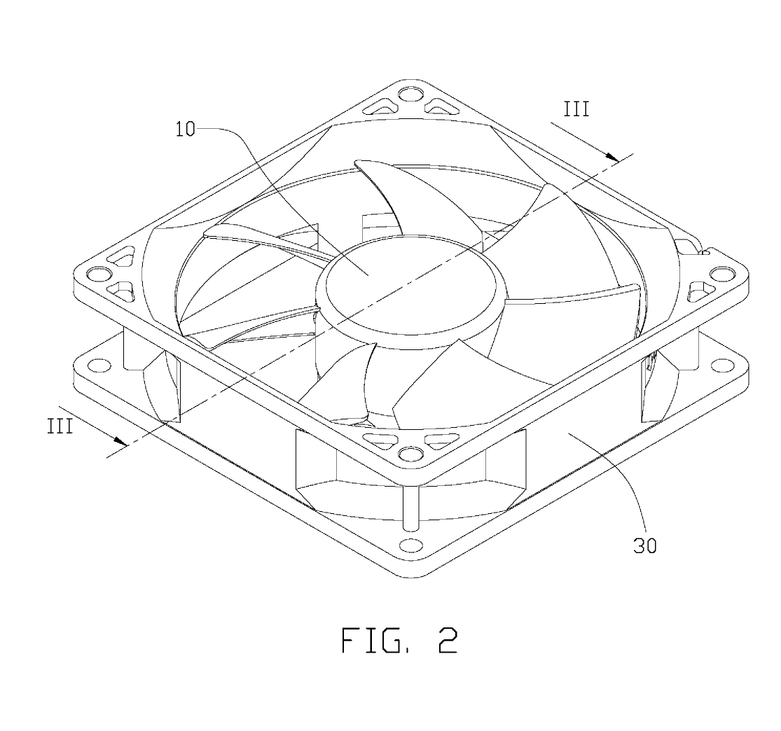

Referring to FIGS. 1 through 3, a cooling fan according to a preferred embodiment includes a fan housing 30, a bearing 61, a rotor 10, and a stator 20 in respective to which the rotor 10 is rotatable.

The fan housing 30 includes a base 32 and a central tube 34 extending upwardly from a central portion of the base 32. The central tube 34 defines a central hole 36 therein and forms an open end at a top portion thereof. An annular recess 38 is formed on an inner circumference of the top portion of the central tube 34. The recess 38 communicates with the central hole 36. Thus the top portion of the central tube 34 has an inner diameter larger than that of the other portion of the central tube 34. A bottom end of the central tube 34 is closed. An annular protrusion 31 extends inwardly from the inner circumference of a bottom end of the central tube 34, and thus forms a step in the central hole 36 at the bottom end of the central tube 34.

The rotor 10 includes a hub 12 forming a shaft seat 120 at a central portion thereof, a plurality of fan blades 14 extending radially from an outer periphery of the hub 12, a magnet 16 adhered to an inner side of the hub 12, and a shaft 18 received in the shaft seat 120 and extending downwardly from a central portion of the shaft seat 120. The shaft 18 defines an annular slot 180 in a circular circumference thereof, near a top end adjacent to the hub 12. An annular notch 184 is defined near a free end 186 of the shaft 18 far from the hub 12.

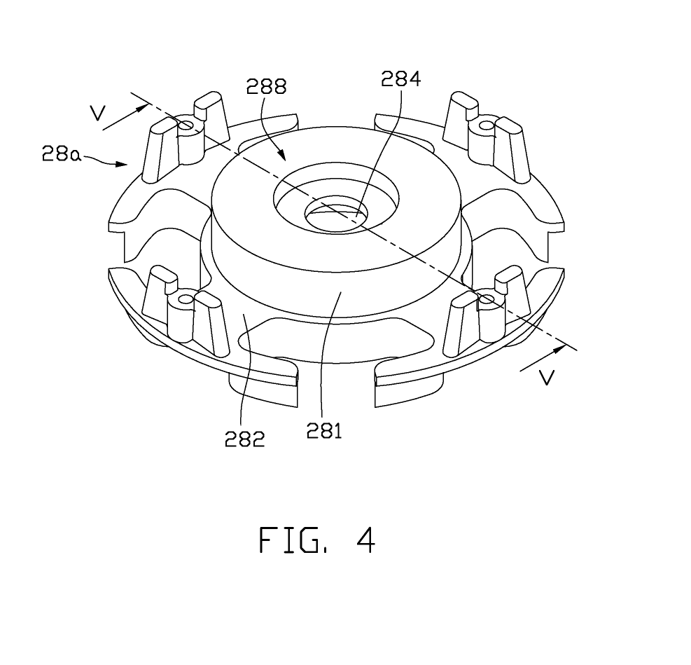

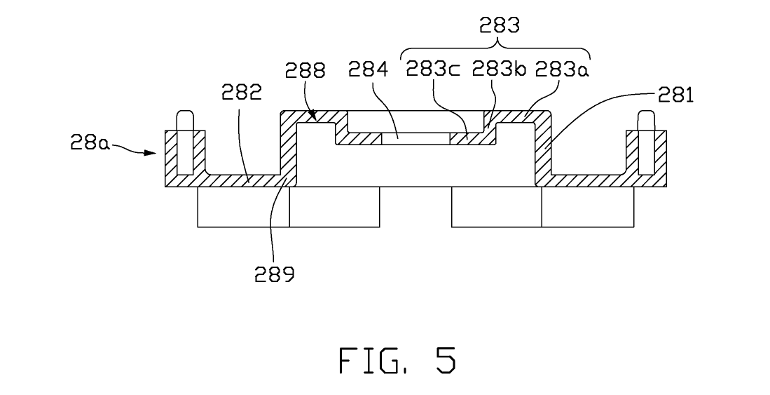

Also referring to FIGS. 4 and 5, the stator 20 includes a stator core consisting of layered yokes 22. Each yoke 22 includes an annular main body and four claws extending radially and outwardly from the main body. Stator coils 24 wind on the claws of the stator core to establish an alternating magnetic field. A PCB 26 (Printed Circuit Board) with electronic components mounted thereon is electrically connected with the stator coils 24 to control electrical current flowing through the coils 24. To avoid the coils 24 from coming into electrical contact with the stator core, upper and lower insulating frames 28a, 28b are used to cover the stator core and electrically insulate the stator coils 24 from the stator core. The insulating frames 28a, 28b are identical to each other, excepting an oil retaining structure 288 formed on a top of the insulating frame 28a as disclosed below. Each insulating frame 28a, 28b (taking the insulating frame 28a as an example) includes an annular ring 289 and four arms 282 corresponding to the main body and claws of the yoke 22.

The oil retaining structure 288 is integrally formed at the top end of the upper insulating frame 28a. The oil retaining structure 288 includes a cylinder 281 extending perpendicularly and upwardly from an inner periphery of the ring 289 of the upper insulating frame 28a, and an annular flange 283 extending inwardly and radially from a top of the cylinder 281 to the outer surface of the shaft 18. The flange 283 defines a through hole 284 therein for extension of the shaft 18. An inner diameter of the flange 283 is approximately the same as or a little larger than an outer diameter of the shaft 18. In this embodiment, the inner diameter of the flange 283 is larger than the outer diameter of the shaft 18, and thus a narrow gap with a width not larger than 0.5 mm is defined between the flange 283 and the shaft 18 to avoid friction generated between the flange 283 and the shaft 18 during operation of the cooling fan.

The flange 283 includes an outer portion 283a extending transversely from the top of the cylinder 281, a middle portion 283b extending perpendicularly and downwardly from the outer portion 283a, and an inner portion 283c extending transversely from the middle portion 283b to the shaft 18. The middle portion 283b of the flange 283 is received in the recess 38 of the central tube 34. An outer diameter of the middle portion 283b is substantially the same as the diameter of the recess 38, and a height of the middle portion 283b is approximately the same as that of the recess 38. When the middle portion 283b of the flange 283 is received in the recess 38 of the central tube 34, the outer portion 283a of the flange 283 covers on the top of the central tube 34, and the inner portion 283c of the flange 283 covers on and substantially encloses the top of the bearing 61.

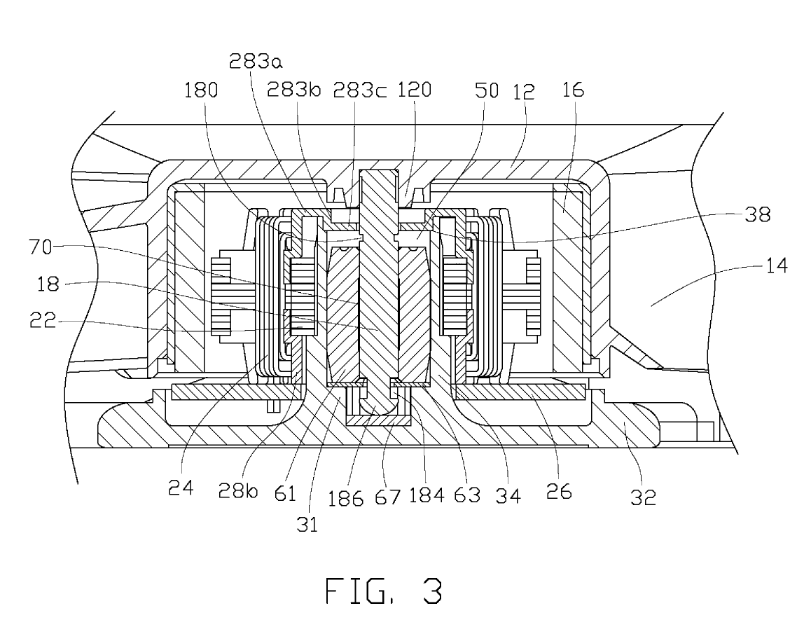

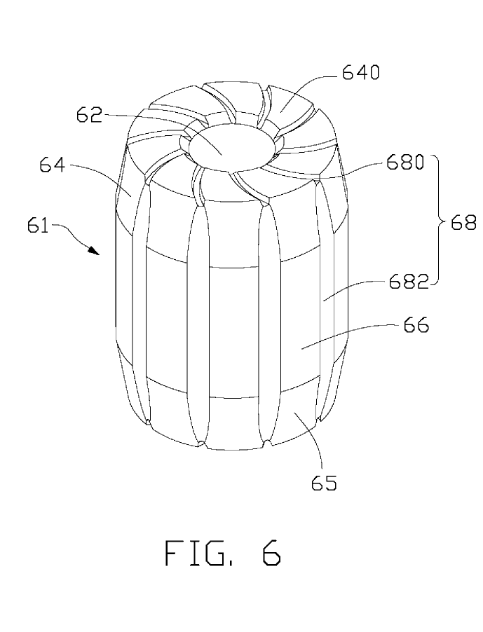

As shown in FIG. 6 and also referring to FIG. 3, the bearing 61 defines an axial hole 62 therein for extension of the shaft 18 therethrough. The axial hole 62 of a middle portion 66 of the bearing 61 has a diameter larger than that of two opposite ends (i.e. top and bottom ends 64, 65) of the bearing 61. The diameter of the axial hole 62 at the two ends 64, 65 of the bearing 61 is approximately the same as the outer diameter of the shaft 18. Therefore when the fan is assembled, a clearance of only 0.002˜0.005 mm is defined between each end 64, 65 of the bearing 61 and the shaft 18 for reducing oil loss of the cooling fan, and a space 70 is defined between the middle portion 66 of the bearing 61 and the shaft 18 for improving the supply of lubrication oil to the bearing 61. In other words, the middle portion 66 of the bearing 61 is spaced from the shaft 18, whilst only the two ends 64, 65 of the bearing 61 contact with the shaft 18 when the shaft 18 rotates. The contacting area between the bearing 61 and the shaft 18 is thus reduced, thereby reducing the friction generated between the bearing 61 and the shaft 18. A chamfer angle is formed at each of the ends 64, 65 of the bearing 61 for facilitating mounting of the bearing 61 in the central hole 36 of the central tube 34.

A plurality of channels 68 are defined in an outer surface of the bearing 61 for flowing back of the lubricant oil into the bearing 61. The channels 68 communicate with the axial hole 62 of the bearing 61. Each of the channels 68 includes a first portion 680 defined in a top and a bottom end surfaces 640 of the two ends 64, 65, and a second portion 682 defined in an outside surface of the bearing 61. The first portion 680 of each channel 68 is curve shaped. In a vertical view, the first portion 680 of each of the channels 68 in the top end surface 640 extends outwardly from the axial hole 62 to the outside surface of the bearing 61 along an anti-clockwise direction as the rotation direction of the cooling fan. Alternatively, the first portion 680 of each of the channels 68 in the top end surface 640 can extend along a clockwise direction corresponding to the rotation direction of the cooling fan when the cooling fan is rotated clockwise. The channels 68 can guide the leaking oil to return back to an oil reservoir (not labeled) defined in a bottom of the central tube 34.

When assembling, the stator 20 is mounted around the central tube 34. The bearing 61 is received in the central hole 36 of the central tube 34 and is arranged on the protrusion 31. The top end of the bearing 61 is lower than the top portion of the central tube 34. The shaft 18 extends through the axial hole 62 of the bearing 61 and thus rotatably engages with the bearing 61. The stator 20, the rotor 10, the central tube 34, and the bearing 61 construct a motor for the cooling fan. The slot 180 of the shaft 18 is located above the top end of the bearing 61. The middle portion 283b of the flange 283 of the oil retaining structure 288 is received in the recess 38 of the top portion of the central tube 34, and the inner portion 283c of the flange 283 of the oil retaining structure 288 is located above the slot 180 of the shaft 18. Thus the inner portion 283c of the flange 283 and the bearing 61 are located at two opposite sides of the slot 180. An oil buffer 50 is defined between the inner portion 283c and the bearing 61. The oil buffer communicates with the slot 180 of the shaft 18. A locking washer 63 is located between the bottom end of the bearing 61 and the protrusion 31 of the central tube 34. The locking washer 63 defines an inner hole 630 therein. The inner hole 630 has a diameter smaller than the diameter of the shaft 18, but larger than the diameter of the portion of the shaft 18 defining the notch 184. Thus the locking washer 63 is engaged in the notch 184 to limit movement of the shaft 18 along an axial direction thereof. A support pad 67 made of high abrasion resistant material is mounted in a bottom end of the central hole 36 of the central tube 34 to face and supportively engage the free end 186 of the rotary shaft 18.

During operation, the rotor 10 is driven to rotate by the interaction of the alternating magnetic field established by the stator 20 and the magnetic field of the rotor 10. Due to the precision clearance formed between the two opposite ends of the bearing 61 and the shaft 18, the bearing 61 enables the cooling fan to run smoothly, stably and with less vibration. The lubrication oil creeps up along the rotating shaft 18 under the influence of the centrifugal force generated by the rotation of the shaft 18 and then escapes to the oil buffer through the clearance defined between the top end of the bearing 61 and the shaft 18. The slot 180 of the shaft 18 prevents the oil from continuously creeping up along the shaft 18. The oil retaining structure 288 can sufficiently prevent the oil from leaking out of the narrow gap between the shaft 18 and the inner portion 283c of the flange 283 of the oil retaining structure 288. Thus the escaping oil is received in the buffer 50 and then flows back to the bearing 61 through the channels 68 of the bearing 61. Therefore the oil can be kept from leaking out of the bearing 61. Good lubrication of the bearing 61 and shaft 18 is thus constantly maintained, thereby improving the quality and life-span of the cooling fan.

It is understood that the invention may be embodied in other forms without departing from the spirit thereof. Thus, the present example and embodiment are to be considered in all respects as illustrative and not restrictive, and the invention is not to be limited to the details given herein.

What is claimed is:

1. A cooling fan comprising:
a fan housing having a central tube extending upwardly therefrom;
a bearing received in the central tube, and defining a bearing hole therein;
a stator mounted around the central tube, comprising a stator core, and upper and lower insulating frames being respectively located at upper and lower sides of the stator core;
a rotor comprising a hub having a shaft extending from the hub into the bearing hole of the bearing; and
an oil retaining structure being integrally formed with the upper insulating frame, and extending inwardly from a top of the upper insulating frame to an outer surface of the shaft.

2. The cooling fan as claimed in claim 1, wherein the oil retaining structure is annular shaped and defines a through hole for extension of the shaft therethrough.

3. The cooling fan as claimed in claim 1, wherein the upper insulating frame comprises a ring and arms extending outwardly from the ring, the oil retaining ring comprising a cylinder extending upwardly from an inner periphery of the ring and a flange extending inwardly from a top of the cylinder.

4. The cooling fan as claimed in claim 3, wherein the flange comprises an outer portion extending transversely from the top of the cylinder, a middle portion extending perpendicularly and downwardly from the outer portion, and an inner portion extending transversely from a bottom end of the middle portion to the shaft.

5. The cooling fan as claimed in claim 4, wherein an oil buffer is defined among the inner portion of the flange, the bearing and the central tube, the oil buffer communicating with the bearing hole of the bearing.

6. The cooling fan as claimed in claim 1, wherein a top portion of the central tube is open and an annular recess is defined on an inner circumference of the top portion of the central tube for receiving the oil retaining structure.

7. The cooling fan as claimed in claim 1, wherein a gap with a width not larger than 0.5 mm is defined between the flange and the shaft to avoid friction therebetween during operation of the cooling fan.

8. The cooling fan as claimed in claim 1, wherein a middle portion of the bearing has an inner diameter larger than that of two ends of the bearing, a space being defined between the middle portion of the bearing and the shaft, and a clearance of 0.002˜0.005 mm being formed between each of the two ends of the bearing and the shaft.

9. The cooling fan as claimed in claim 1, wherein at least one channel communicating with the bearing hole of the bearing is defined in an outer surface of the bearing, the at least one channel comprises a first portion defined in top and bottom end surfaces of the bearing and a second portion defined in an outside circumferential surface of the bearing.

10. An insulating frame for a motor stator, comprising:
a ring with a plurality of arms extending outwardly from the ring, the ring being adapted for mounting on a top of the motor stator for insulating a stator core of the motor stator from stator coils wound on the stator core; and
an oil retaining structure integrally extending inwardly from a top of the ring, adapted for helping preventing oil leak of a bearing around which the motor stator is mounted.

11. The insulating frame as claimed in claim 10, wherein the oil retaining structure comprises a cylinder extending upwardly from an inner periphery of the ring and a flange extending inwardly from a top of the cylinder.

12. The insulating frame as claimed in claim 11, wherein the flange comprises an outer portion extending transversely from a top of the cylinder, a middle portion extending perpendicularly and downwardly from the outer portion, and an inner portion extending transversely from the middle portion of the flange.
